(19) United States
(12) Patent Application Publication
(10) Pub. No.: US 2017/0254694 A1
(43) Pub. Date: Sep. 7, 2017

(54) ONBOARD LOAD WEIGHT MEASUREMENT SYSTEM FOR VEHICLES, WITH A MULTIPOINT AUTOMATIC AND SEMI-AUTOMATIC CALIBRATION SYSTEM

(71) Applicant: TOIGO IMPORTADORA E DISTRIBUIDORA DE SISTEMAS AUTOMOTIVOS LTDA, Caxias do Sul (BR)

(72) Inventor: FREDERICO TIETBOHL TOIGO, Caxias do Sul (BR)

(21) Appl. No.: 15/448,567

(22) Filed: Mar. 2, 2017

(30) Foreign Application Priority Data
Mar. 4, 2016 (BR) 102016004840-0

(51) Int. Cl. G01G 19/12; G01G 23/01

(52) U.S. Cl. CPC G01G 19/12; G01G 23/01

(57) ABSTRACT

This invention comprises an onboard load weight measurement system for vehicles, with air, mechanical or both suspensions, comprising a master weight measurement module with up to eight communication channels, which can be interconnected to slave modules, with up to eight communication channels, by cable or wireless via data transmission/reception modules, which are connected to sensors that vary between different sensors for air suspension installed in the air lines of the air suspension through a “T” and/or, for mechanical suspension, rectilinear displacement transducer with inductive or resistive effect sensors, preferably fixed in pairs on each vehicle axle, one at each end of the axle, between the chassis and the mechanical suspension, having diverse fixing configurations. The system calculates the individual weight for each vehicle wheel, vehicle axle extremity, vehicle axle side, vehicle axle or a group of vehicle axles, as well as its tare, net load or total gross weight loaded.

### CROSS-REFERENCE TO RELATED APPLICATIONS

The present application claims priority under 35 U.S.C. 119, 35 U.S.C. 365 and 37 C.F.R 1.55 to Brazilian Patent Application 102016004840-0 (filed on Mar. 4, 2016), which is hereby incorporated by reference in its entirety.

### INVENTION FIELD

The invention is an onboard load weight measurement system for vehicles, where measurement can be performed individually on each wheel of the vehicle, by each axle or by a group of axles of the vehicle, on each side of the vehicle axle, or on each extremity of the vehicle's axle, as well as its tare, net load or total gross weight, statically and dynamically, in any vehicle with mechanical or air suspension, or both combined. The invention has a multipoint calibration system, whereas this calibration can be performed semi-automatically or automatically (in static or dynamic forms) by using ground scales. The invention also has a suspended vehicle axle detection system for the correct operation of the system under different load conditions.

### BACKGROUND OF THE INVENTION AND CHARACTERISTICS

The state-of-the-art features a few onboard load weighing systems for vehicles, such as those describing the installation of load cells between the hopper rails and the vehicle's chassis, with an indicator that only informs the net weight of the vehicle's load; or systems that describe the installation of load cells or strain gauges on the springs and/or vehicle axles, with an indicator that informs the weight per axle, net weight and total weight of the vehicle load. Also, systems that describe the use of a laser or ultrasonic sensor for the height variation measurement, glued to the suspension springs of the vehicle, with an indicator that informs the weight per axle, net weight and total load weight of the vehicle; or the use of an inclinometer glued to the suspension springs of the vehicle, with an indicator that informs the weight per axle, net weight and total load weight of the vehicle.

In addition, the communication between the measurement and reading modules reported in the state-of-the-art still specifies the need of wiring, with the reading module generally placed in the vehicle cabin, without the possibility of remote monitoring of one or more trailers and/or dollies by the user, as permitted by this invention.

Accordingly, it is desirable that the communication between the modules of the weighing system offers the option to eliminate the wiring for communication between the modules, whereas this is one of the features of this invention.

Also, it should be noted that the installation of the load cell type sensors or strain gauges, usually used and reported in the state-of-the-art, require the acts of sanding, welding, gluing and other types of fixation that are laborious and require specialized labor force. In the case of load cells installed between the hopper rails and the vehicle chassis, in addition to being very laborious in their installation for demanding the removal of the implement from the chassis in used vehicles; and special project to install in new vehicles, they also require several hours of installation time, making it very costly and laborious, since it requires specialized labor force and equipment to move heavy loads.

It should also be noted that both abovementioned systems suffer from problems of low durability (service life), due to the use of load cells that have an estimated useful life of between 100,000 (one hundred thousand) and 300,000 (three hundred thousand) cycles, resulting in an average estimated period between 3 (three) and 6 (six) months of operation, when it may present the need to change the sensors, which requires the removal of the implement from the vehicle's chassis for maintenance and/or replacement.

It is desirable that the installation of the sensors of an onboard scale system features more practicality and time reduction, besides the elimination of the need to remove implements from the chassis for installation or maintenance, as well as the number of tools used.

Thus, this invention, unlike the already existing systems described in the state-of-the-art, consists in the use of rectilinear displacement transducer with inductive or resistive effect sensors, with rod ends attached in each extremity, fixed to the suspension and the vehicle's chassis only by screws and nuts, using two sensor fixing points. The use of this type of sensor still presents a time gain in the part's installation, maintenance and replacement process, presenting a useful life of between 1,000,000 (one million) to 100,000,000 (one hundred million) cycles, which results in an average estimated period between 1 (one) and 10 (ten) years of operation; i.e., much superior to the existing abovementioned systems, therefore solving a technical problem.

Also, it is important to note that the installation of load cells and/or strain gauge type sensors on the vehicle axles, as described in the state-of-the-art, results in onboard scale systems suffering from warpage problems of the vehicle axles, caused by holes or bumps on the suspension due to its usual construction materials, which have not undergone a heat treatment and has a low elastic regime, causing malfunction of the onboard scale system and generating errors in the values presented to the user, as well as the necessity for unnecessary re-calibrations.

Thus, this invention consists in the use of sensors to measure the height variation through rectilinear displacement transducer with inductive or resistive effect sensors, for weight measurement, fixed directly to the vehicle suspension, of which springs are made of noble material (alloy steels), which allows different heat treatments that allow a greater elastic regime, less warping, greater data repeatability and also greater sensitivity on the sensors due to the greater spring deflection/flexion in relation to the axle's deflection/flexion. It also requires a smaller number of re-calibrations, even eliminating them, when compared to systems using load cells or strain gauges, because this system is based on height variation of the spring which does not warp, unlike the axles, therefore solving this technical problem presented in the already existing systems.

It is also worth mentioning the difference for the laser or ultrasonic type sensors, also described in the state-of-the-art, which require constant cleaning, since their measurement is extremely affected by the natural dirt that affect vehicles, especially the load ones (mud, water, dust, etc.), altering the measured values and causing greater error and imprecision of the system.

Thus, it is desirable that the sensors are not affected by dirt and water, being necessary for the height measurement sensor to have a high IP protection rate, which is why this invention uses rectilinear displacement transducer with inductive or resistive effect sensors, which have an IP protection 65 to 69, with an operating principle that does not change with this type of interference (dirt in general, like mud, water, dust, etc.), therefore solving the technical problem presented in the existing systems, described as state-of-the-art.

It is also worth mentioning the difference for angular type sensors, which use several articulated and/or pivoted arms, which ends up increasing greatly the measurement error margin, since they have gaps that multiply with time, thus increasing the measurement error margin during use. These systems use only 1 (one) sensor per axle, which greatly increases the measurement error margin, due to the fact that it does not compensate the weight between axles, by load imbalance or the unevenness of the ground where the vehicle is located at the time of the weighing.

It's important to note another difference of the present invention for those already existing systems that utilize ultrasonic type sensors, inclinometers and/or strain gauges glued to the vehicle's leaf springs, since they suffer with sensor detachment problems in their normal use in a short period (average between 1 and 6 months of use). Even if several types of glues or techniques are used for the installation, the sensor, in these cases, tends to detach from the leaf springs, either because they are not made of the same material (which generates different thermal dilation in the materials) or due to the mechanical stress of the flexion/deflection of the spring, which causes the sensor to detach.

Thus, it is desirable that the sensors are not affected by the flexion/deflection movement of the spring and neither by the thermal dilation, having robust mechanical fixation, however of easy installation, not suffering with this type of interference, which translates one of the main characteristics of this invention, namely, ease of installation and subsequent maintenance; therefore solving the technical problem presented in the already existing systems.

This invention further features a semi-automatic or automatic calibration system, which represents a technical solution to the calibration problem of all other types of existing onboard scales, for which ground scales are required and operators to read, write down and pass the values measured by these ground scales to the onboard scales manually, generating the need for the technician to go to the location to perform the process. Thus, this invention, in addition to allowing this reported manual calibration, relies on a remote calibration system, by using ground scales that communicate directly with the onboard scale system, object of this invention, thereby performing a semi-automatic or automatic calibration of the system when the vehicle stops or passes over the ground scales, thus solving the technical problem in the already existing systems.

This invention allows the user to calibrate the system with two or more calibration points, up to 10 (ten) points, to optimize the system performance across all weight ranges. This is a solution to a technical problem verified in the state-of-the-art, since other onboard weighing systems use only two calibration points, which only works satisfactorily for air suspension vehicles because of their linear behavior; in vehicles with mechanical suspension, in turn, the springs work progressively and the suspension behaves as a parabola, which generates the need for more calibration points for the correct monitoring of this curve, whereas this invention is the solution to this problem. The function of the multiple calibration points is to optimize the system as a whole, minimizing the error in all weight ranges and allowing less error and greater profitability to the final consumer, whereas this is one of the differentials of the technique of this system.

This invention enables the onboard scale system to identify and/or register the vehicle's suspended axles, as to compute the axle weights correctly. Such a characteristic is necessary in vehicles having axles equipped with suspenders, when said suspended axles are raised at the time of the weighing.

It is known that axle suspenders have the function of suspending from the ground the axle equipped with it, transferring to the other vehicle axles the weight that was borne by it. This makes the current onboard weighting systems, inserted in the state-of-the-art, point to a large error in the measurement of the load in vehicles equipped with suspenders, since they do not anticipate this type of situation and end up counting the weight value of the suspended axles in the total weight. This negatively influences the result of the total weight of the vehicle, increasing the system error as a whole.

In order to overcome this problem, this invention provides the solution of a calibration that identifies when the axle is suspended. Also, an algorithm can be inserted in the firmware of the onboard weighting system for an automatic identification of the axles that are suspended. After identifying this situation, the system removes from the total weight formula the axle(s) that is(are) in this condition, in order to provide the vehicle's weight correctly; it also indicates to the user and third parties, through a remote monitoring system, which axles are suspended, for the purpose of helping control the vehicle's tires and fuel, as well as providing a remote monitoring for the fleet manager, resulting in a technical solution to an existing technical problem.

This invention has a data storage system via RAM, SD or mini SD, for posterior download. The system compares the vehicle weight with the measurement date and time data, allowing the fleet manager, inspection bodies and other interested users to view the detailed information, thus being able to generate reports and graphs with the data for later analysis, solving, therefore, a technical problem in the already existing systems.

The USB port system present in the system allows to record data in pen drives or to update the firmware of the equipment without needing to send it to the manufacturer, by simply inserting the pen drive with the updated firmware in the system's display.

The Can Bus system present in the system allows communication with other machines and with the vehicle's original module or multimedia center, in order to allow the user to view the information of the onboard weighting system directly on the vehicle's original panel, thus centralizing the information without the need to install a dedicated system display. Such a feature allows vehicle manufacturers to record the information in the vehicle's original module, whereas this is yet another differential of the technique of this system.

It is known that tractor vehicles equipped with onboard scales, when coupled to other vehicles such as trailers, dollies, etc., cannot inform the weight of these coupled vehicles on the same display inserted in the cabin of the tractor vehicle, so the user does not have access and direct contact with the information. This causes the user to need to get out of the vehicle to check the weight of vehicles coupled directly to the external display of these vehicles, which makes the process slow and dangerous to the user.

This invention has an innovative system, as it solves this technical problem, which allows the user to couple and decouple different vehicles equipped with the onboard weighting system automatically or manually. In the manual process, the user enters the license plate number, chassis or other identification number on the display and authorizes the coupling or decoupling of the regarded vehicle; in the automatic process, it uses wireless technology or tags for automatic recognition of the coupled vehicle(s), whereas it(they) can always decouple when desired. The identification information of the coupled vehicles is recorded in the system's memory as to facilitate future couplings of the same vehicle and also allows the display to add and display the information to the user directly in the vehicle's cabin or still remotely to third parties.

Finally, it is emphasized that the possibility of visualizing the data measured by the already existing equipment described in the state-of-the-art, is given only to the user inside the vehicle's cabin or on the external displays, making it impossible for the fleet manager to remotely view the data, or generate reports of the presented data, due to the lack of communication or storage of information with GSM, satellite or radio, telemetry, data loggers, printers, vehicle's original module, SD/mini SD memory card, Wi-Fi, Bluetooth, USB connection, or remote panels, which is also solved by this invention.

### BRIEF DESCRIPTION OF THE DRAWINGS

FIG. 1 shows a schematic representation of the onboard load weight measurement system for vehicles, with their respective references:
(1) Ground scales;
(2) Master/slave module;
(3) Data transmission/reception module;
(4) Display;
(5) Vehicle chassis;
(6) Mechanical suspension;
(7) Tractor truck/bus/cars;
(8) Trailer/dolly;
(9) Vehicle cabin;
(10) SD/mini SD card;
(11) USB port;
(12) RS485 Port 1;
(13) RS232 Port 1;
(14) Can Bus Port;
(15) RS485 Port 2;
(16) RS232 Port 2;
(17) Rectilinear displacement transducer with inductive or resistive effect sensor;
(18) Air suspension sensor;
(19) Air suspension;
(20) Load cells;
(21) Miscellaneous peripherals;
(22) Communication peripherals;
(23) Vehicle's original module.

FIG. 2 shows the operation flowchart of the onboard load weight measurement system for a vehicle equipped with mechanical suspension.

FIG. 3 shows an overview of the sensor installation version parallel to the vehicle' dampers.

FIG. 4 shows a detailed view of the method to fix the sensor parallel to the vehicle's damper.

FIG. 5 shows a front view of the method to fix the sensor parallel to the vehicle's damper.

FIG. 6 shows a perspective view of the method to fix the sensor in front of or behind the front dampers of the vehicle.

FIG. 7 shows a perspective view of the method to fix the sensor in front of or behind the front dampers of the vehicle.

FIG. 8 shows an overview of the method to fix the sensor inserted in the vehicle's damper.

FIG. 9 shows a detailed view of the method to fix the sensor inserted in the vehicle's damper.

FIG. 10 shows a detailed view of the method to fix the sensor fastened to the vehicle's spring clamps.

FIG. 11 shows a detailed view of the method to fix the sensor fastened to the vehicle's spring clamps.

FIG. 12 shows an overview the method to fix the sensor fastened to the fixed spring bearing and the master pin of the leaf spring of the vehicle.

FIG. 13 shows a detailed view of the method to fix the sensor fastened to the fixed spring bearing and the master pin of the leaf spring of the vehicle.

FIG. 14 shows an overview of the method to fix the sensor fastened to the vehicle's leaf spring blades.

FIG. 15 shows a detailed view of the method to fix the sensor fastened to the vehicle's leaf spring blades.

FIG. 16 shows an overview of the method to fix the sensor fastened to the fixed spring bearing and the leaf spring U-bolt's bracket of the vehicle.

FIG. 17 shows a detailed view of the method to fix the sensor fastened to the fixed spring bearing and the leaf spring U-bolt's bracket of the vehicle.

FIG. 18 shows an overview of the method to fix the sensor fastened to the fixed spring bearing and the mobile bearing/shackle of the leaf spring of the vehicle.

FIG. 19 shows a detailed view of the method to fix the sensor fastened to the fixed spring bearing and the mobile bearing/shackle of the leaf spring of the vehicle.

FIG. 20 shows an overview of the method to fix the sensor fastened between the spring clamp and a bracket fastened to the vehicle's chassis.

FIG. 21 shows a detailed view of the method to fix the sensor fastened between the spring clamp and a bracket fastened to the vehicle's chassis.

FIG. 22 shows a perspective view of the method to fix the sensor fastened between a bracket on the spring U-bolt and a bracket fastened to the vehicle's chassis.

FIG. 23 shows a perspective view of the method to fix the sensor fastened between a bracket on the spring U-bolt and a bracket fastened to the vehicle's chassis.

FIG. 24 shows an overview of the method to fix the sensor fastened between a bracket fastened to the master pin of the leaf spring and a bracket fastened to the vehicle's chassis.

FIG. 25 shows a detailed perspective view of the method to fix the sensor fastened between a bracket fastened to the master pin of the leaf spring and a bracket fastened to the vehicle's chassis.

FIG. 26 shows an overview of the method to fix the sensor fastened with a hole or stud on the blades of the leaf spring and to a bracket fastened to the vehicle's chassis.

FIG. 27 provides a detailed view of the method to fix the sensor fastened with a hole or stud on the blades of the leaf spring and to a bracket fastened to the vehicle's chassis.

FIG. 28 shows a perspective view of the method to fix the sensor fastened between the axle and the vehicle's chassis.

FIG. 29 shows a detailed view of the method to fix the sensor fastened between the axle and the vehicle's chassis.

FIG. 30 shows a perspective view of the method to fix the sensor fastened between the axle and the vehicle's chassis.

FIG. 31 shows a detailed view of the method to fix the sensor fastened between the axle and the vehicle's chassis.

FIG. 32 shows an overview of the method to fix the sensor between the axle and the vehicle's chassis.

FIG. 33 shows a detailed view of the method to fix the sensor between the axle and the vehicle's chassis.

FIG. 34 shows a front view of the system calibration process.

FIG. 35 shows a perspective view of the system calibration process.

FIG. 36 shows a perspective view of the system calibration process.

FIG. 37 shows a perspective view of the system calibration process.

FIG. 38 shows a perspective view of the system calibration process.

### DETAILED DESCRIPTION OF THE INVENTION

### System Overview

This invention comprises an onboard load weight measurement system for vehicles (FIG. 1), whereas the measurement can be performed on each wheel, axle, group of axles, axle extremity or on only one side of the vehicle's axle(s); as well as accurately measure its tare, net weight and total gross weight, statically (vehicle stopped) or dynamically (vehicle in movement), on any vehicle with mechanical or air suspension, or a combination of both, by the use of rectilinear displacement transducer with inductive or resistive effect sensors, with rod ends attached in each extremity, fixed to the suspension and the vehicle's chassis only by screws and nuts, using two sensor fixing points.

The system consists of a master module (2) that communicates with the slave module(s) (2) and the display (4), either via cable or wireless (by using transmission/reception modules (3), allowing the user to access the data collected by the system in the vehicle's cabin (9) and/or on the side of the trailer/dolly (8) and/or on the ground scale (1), thus having data from multiple vehicles at the same time, as long as each slave module is paired to the master module.

The master module differs from the slave module(s) because it is directly connected to communication peripherals (22) by GSM, satellite, radio, telemetry and/or data loggers, whereas such connections are made through two RS485 ports (12) (15), two RS232 ports (13) (16) or the Can Bus Port (14). In addition, the master module can be connected directly to the vehicle's original module (23) through the Can Bus Port (14). Finally, the master module can connect to SD/mini SD memory card (10), as well as other peripherals (21) such as printers, Wi-Fi modems, Bluetooth, vehicle's original panel; and USB connection (11).

The master module, in addition to capturing the information collected by the sensors connected to its multiple channels, also receives the information collected and transmitted by the slave module(s) via cable or via the data transmission/reception module (3), so that after the coupling of the mechanical tractor (7) to the trailer/dolly (8), the weight values of each vehicle can be summed up and also informed if the axles are on the ground or suspended; thus correctly informing the sum of the weight of the whole set, providing the final information directly on the display(s) (4), and can also communicate and store the information through the diverse peripherals and abovementioned storage options.

The master module is usually installed on the mechanical tractor/bus/car (7) or on the trailer/dolly (8) equipped with a dedicated tracker or other equipment for remote transmission (telemetry) of its data. The slave module(s) is usually installed on trailers/dollies (8) that do not have a tracker or other remote data transmission equipment installed, which is why they must always send the collected information to the master module. Both master and slave modules can be connected directly to displays (4) located in the vehicle's cabin (9) or on the side of the chassis (4) (8) to display the weights of the vehicle equipped with this system.

The system allows the user to also know if the vehicle axle is suspended in those vehicles that have axle suspenders, whereas such information can be viewed on the display (4) or passed remotely to third parties via the communication peripherals (22). The system allows to exclude from the sum of the total weight or net weight, the weight of the axle or axles that are suspended, for a correct and precise calculation of the onboard weight.

The modules, master and slave(s), have multiple individual channels (totaling eight channels per module), and a channel can be assigned to each sensor installed on a wheel, axle, group of axles, axle extremity, one side of the axle, or a vehicle, according to the sensor model used, if rectilinear displacement transducer with inductive or resistive effect sensors (17) for mechanical suspensions (6), or other air suspension sensors (18) commonly used for air suspension (19), such as angular type resistive sensors, hydraulic or pneumatic pressure sensors, load cells or strain gauges. The final composition of the system will depend on the configuration of the vehicle and its suspensions and the user's choice, whereas 8 (eight) channels are available per module (2) to connect different types of sensors.

When the system is configured with a master module and one (or more) slave module(s), it is necessary that all modules are properly paired, which can be done through the system display (4) or the communication peripherals (22). The system allows this pairing to be done via the vehicle's license plate, chassis number, or by an internal reference number of the user; pairing can be done manually, semi-automatically or automatically (by using tags and tag readers).

In vehicles equipped with air suspension, it must be clarified that the technique used to measure the loaded weight does not differ from that reported in the state-of-the-art, requiring the installation of a “T” in each air suspension air line (19), whereas the sensor (18) being coupled to one of the “T” ends of the air line, fastened between the vehicle's chassis (5) and the vehicle's air suspension (19). This system, nonetheless, allows to measure the loaded weight in vehicles that have different types of suspension in their axles (a combination of mechanical and air suspension, for example), which is not verified in the other systems reported in the state-of-the-art.

In vehicles equipped with mechanical suspension (6), rectilinear displacement transducer with inductive or resistive effect sensors (17) are used, to measure the distance between the chassis (5) and the vehicle's mechanical suspension (6), using up to 2 (two) sensors per axle. The system configuration that reflects the highest precision in the collected information is the one that uses 2 (two) sensors per axle, whereas it is recommended to use only 1 (one) sensor per axle only in the case of cost reduction, with the use of 2 (two) axle sensors to optimize the performance of the weighing system.

The use of 2 (two) sensors per axle also results in the possibility of using the system on uneven grounds and/or to measure uneven loads, since this configuration allows to compensate the weight between both sides of the suspension on the same axle, which is in practice not feasible through the systems described in the state-of-the-art, since they do not perform the necessary compensation due to the mentioned unevenness, because they use a maximum of 1 (one) sensor per axle, positioned in the middle of the axle or at only one of the axle extremities, along with the fact that they do not have the availability of multiple channels in the same module; which results in large measurement errors on uneven grounds or in uneven loads, which is not the case in this invention.

Operation of the Weighing System in Vehicles with Mechanical Suspension

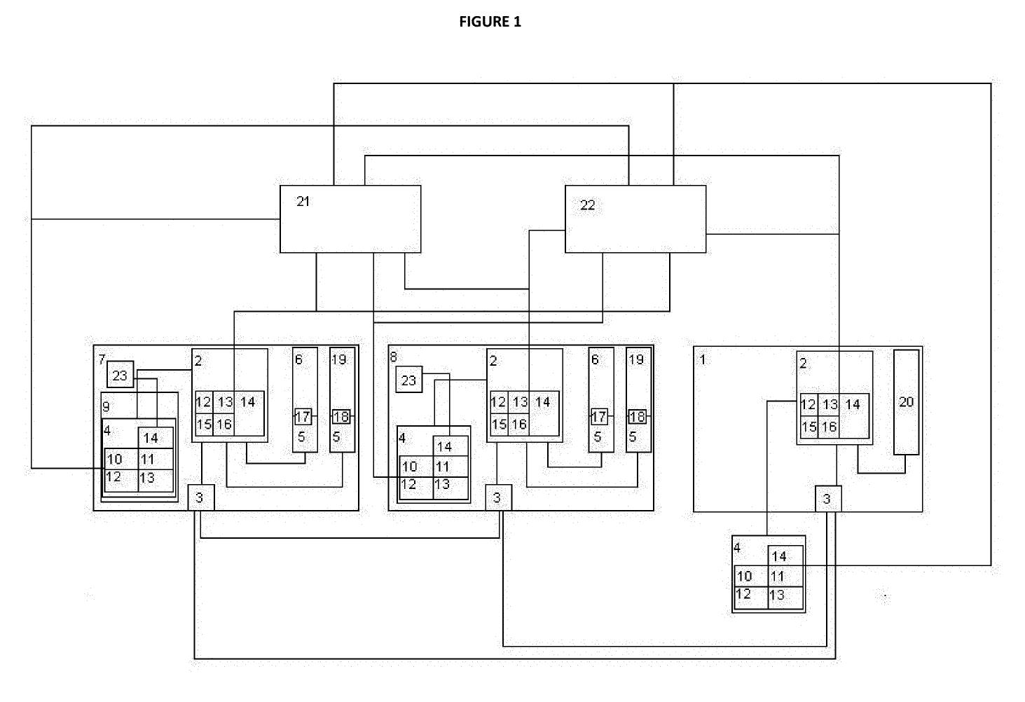

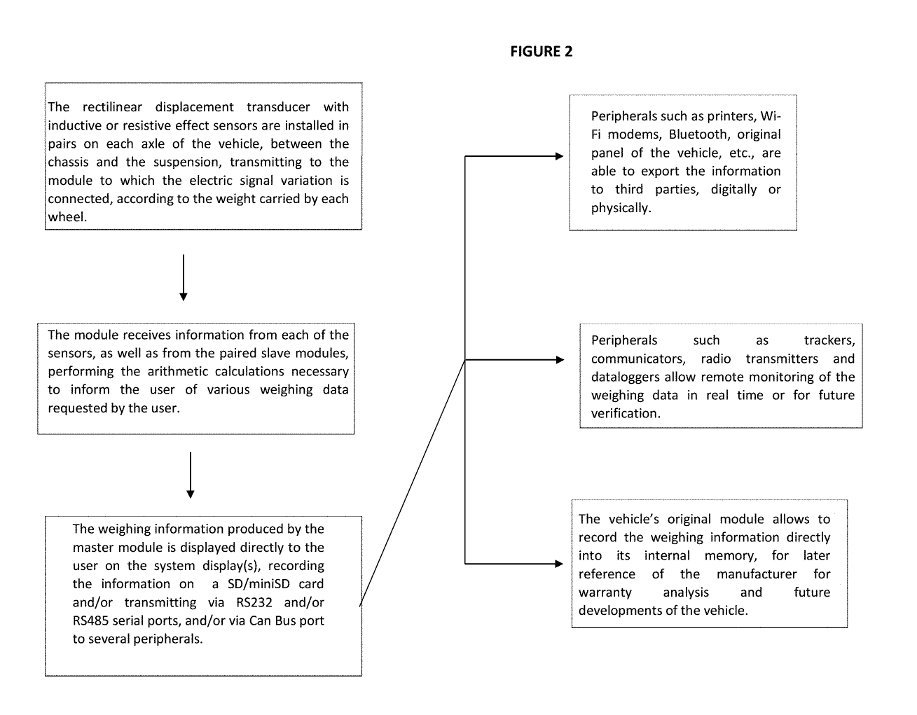

FIG. 2 shows the operation flowchart of the system for vehicles equipped with mechanical suspension, using the references contained in FIG. 1 for a better presentation of the operation as a whole.

The rectilinear displacement transducer with inductive or resistive effect sensors (17) are preferably installed in pairs, one at each end of the axle, on each axle of the vehicle where the load will be measured, fixed between the chassis (5) and the mechanical suspension (6).

The sensors measure the distance between the chassis (5) and a point of the mechanical suspension (6) of the vehicle, according to the loaded weight, individually by wheel or axle extremity (for axles equipped with double tires), transmitting to the module (2) to which it is connected by cable, the variation of the internal electrical signal determined by each sensor in volts, millivolts, amps or milliamps. The module, in turn, performs the arithmetic calculations necessary to inform the user of diverse data requested, such as individual weight for each wheel, for each axle extremity, for each side of the axle, for each axle or for a group of axles of the vehicle; as well as its tare, net load or the gross total loaded weight.

For the sensors connected to the master module, the information is transmitted directly via cables. The sensors connected to the slave module(s) transmit the information via cable to these, which in turn, transmit the calculated values to the master module with which they are paired via cable or wireless (using data transmission/reception module(s) (3).

The master module, upon receiving the information sent by the slave module, performs the arithmetic calculations to inform the summed weights of all the modules of the system. The slave module, in turn, only informs the values regarding the vehicle in which it is installed.

The weighing information produced by the master and slave modules can be shown directly on the display(s) (4), both in those inserted in the cabin of the vehicle (9)(4), as well as on the displays that can be fixed to the sides of the trailers/dollies (8)(4), or even on the display on ground scale(s) (1)(4). The display(s) can be connected to SD/mini SD card (10), as well as to other peripherals (21) such as printers, Wi-Fi, Bluetooth and the vehicle's original panel; and USB connection (11). This allows the collected information to be sent to a third party digitally or physically (printout).

In addition, the display(s) can be connected directly to the vehicle's original module (23) via the Can Bus Port (14). This allows the weight information to be recorded directly into the vehicle's original module memory. It also allows the weighing information to be displayed directly on the vehicle's original panel.

The information collected by the master module can also be sent via communication peripherals (22) via GSM, satellite, radio, telemetry and/or data loggers, with such connections being made via two RS485 (12)(15) ports, two RS232 (13)(16) ports or Can Bus Port (14).

### Sensor Fixing Configurations

It must be noted that the system allows a range of sensor fixing configurations in vehicles equipped with mechanical suspension, which can be: on the vehicle's dampers; on the vehicle's springs; between the vehicle's springs and chassis; and between the vehicle's axle and chassis. Each of these configurations has its own characteristics, all of which are, however, interrelated so as to comprise a single inventive concept of this system.

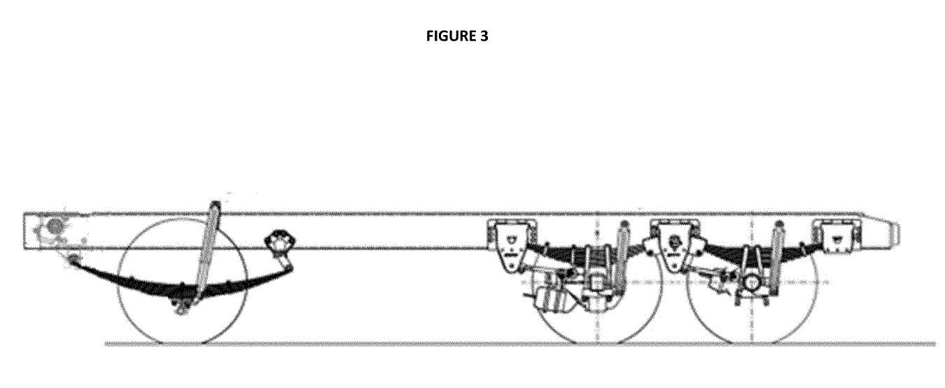

### Detailed Description of the Sensor Fixing Configuration on the Vehicle's Dampers—FIGS. 3 to 9

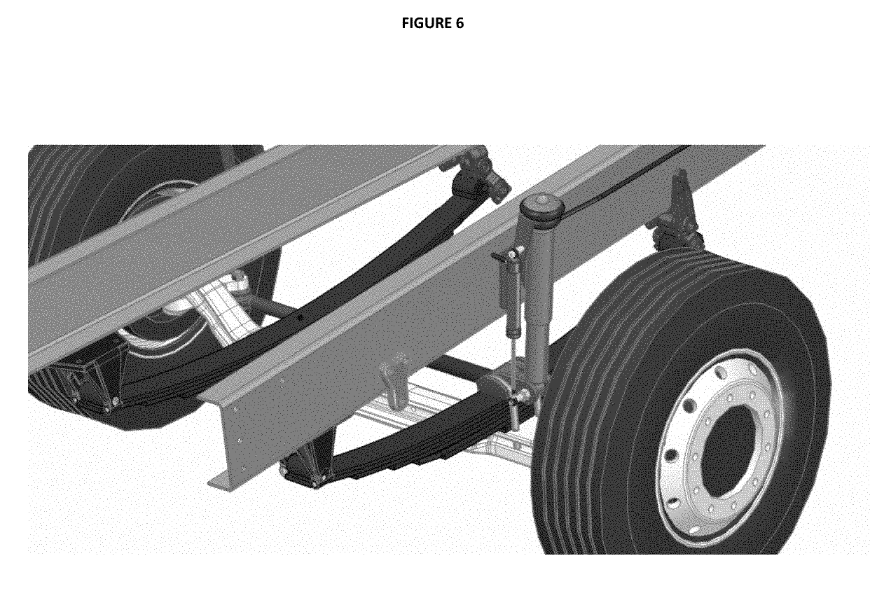

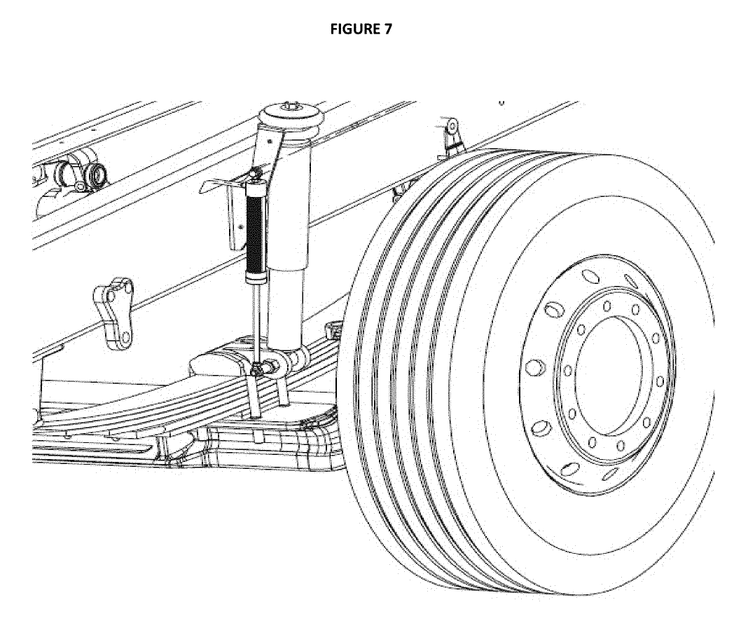

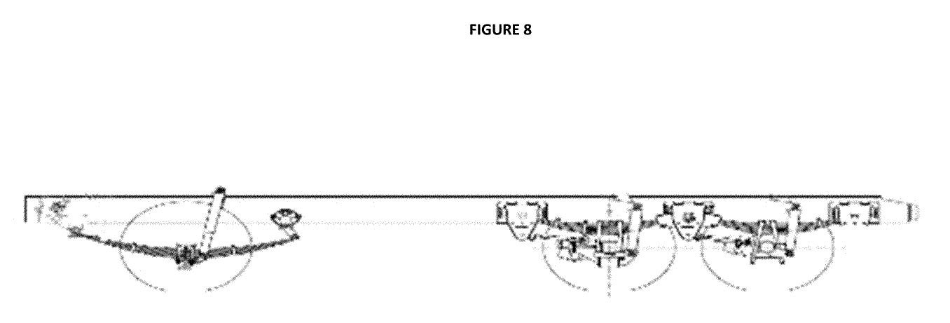

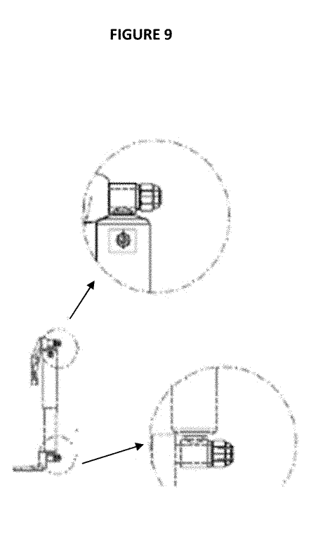

The rectilinear displacement transducer with inductive or resistive effect sensors can be installed on the vehicle's dampers in the following ways: a) parallel to the dampers (FIGS. 3 to 5); b) in front of or behind the damper (FIGS. 6 and 7); or c) inserted in the damper (FIGS. 8 and 9).

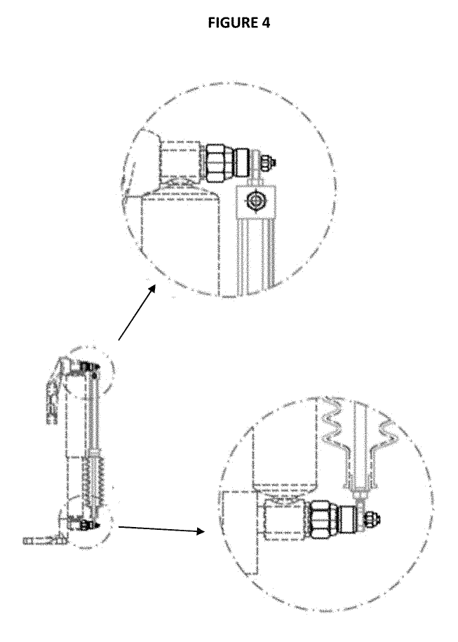

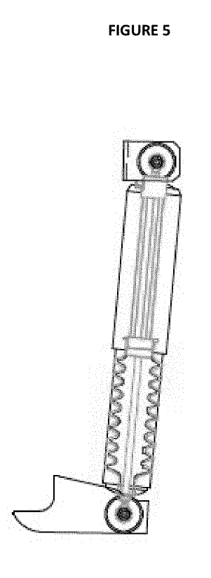

In the installation version parallel to the vehicle's dampers (as shown in the overview of FIG. 3), the rectilinear sensors, which have rod ends attached in each extremity, are fixed by nuts and studs screwed directly to the hexagonal head of the vehicle's original damper fastening bolt (FIGS. 4 and 5), using nuts and lock nuts, if necessary.

In the installation version either in front of or behind the damper (FIGS. 6 and 7), the rectilinear sensors, which have rod ends attached in each extremity, are fixed by nuts and studs screwed directly to the hexagonal head of the vehicle's original damper fastening bolt, using nuts and lock nuts, if necessary, or even using part of the vehicle's structure together with the dampers.

In the installation version inserted in the damper (overview in FIG. 8), the sensors are fastened internally in the damper body, using the structure of the damper itself and its usual fastening points. The sensor can be screwed or threaded in the damper's body (FIG. 9).

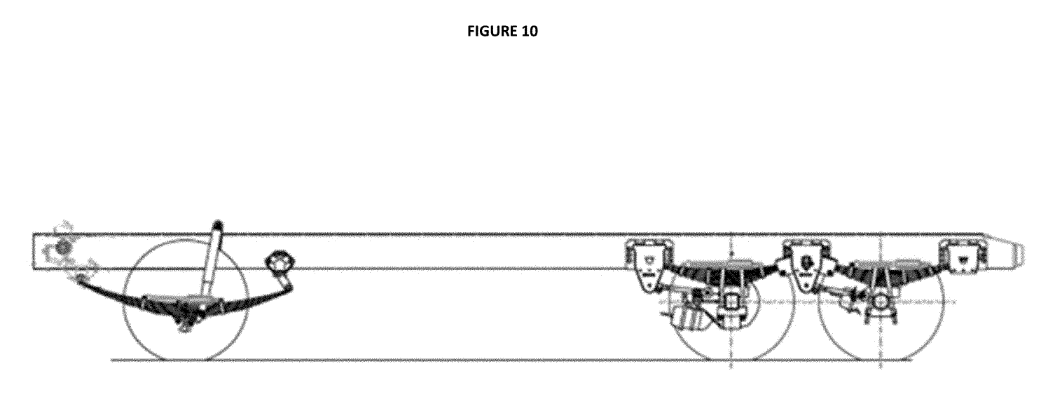

### Detailed Description of the Sensor Fixing Configuration on the Vehicle's Springs—FIGS. 10 to 19

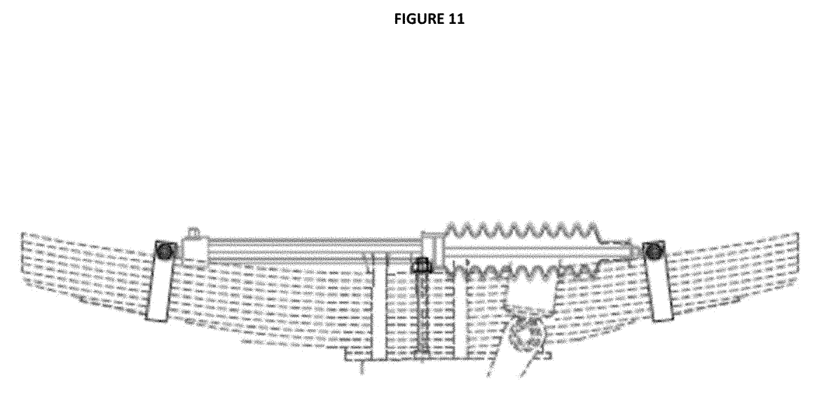

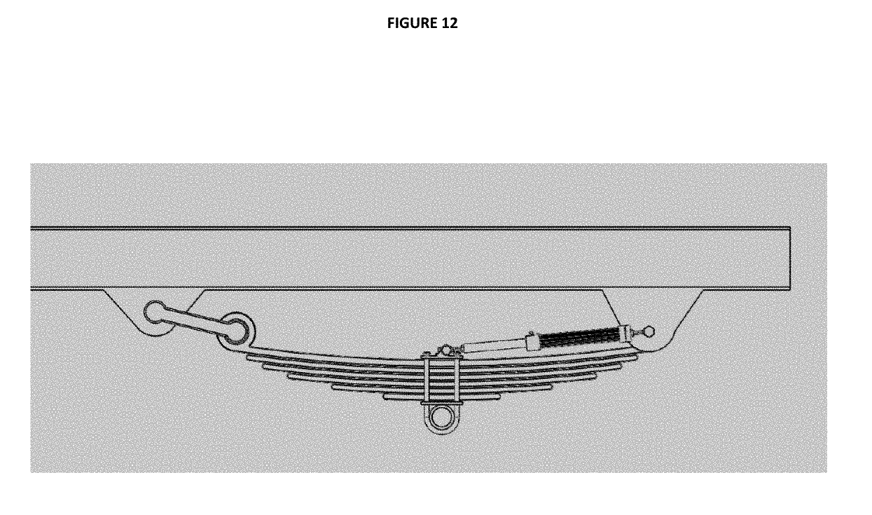

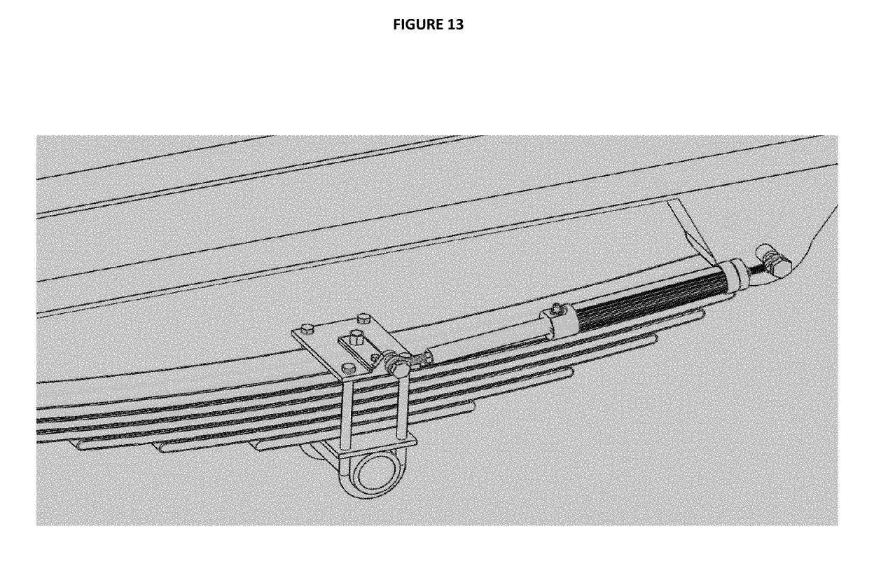

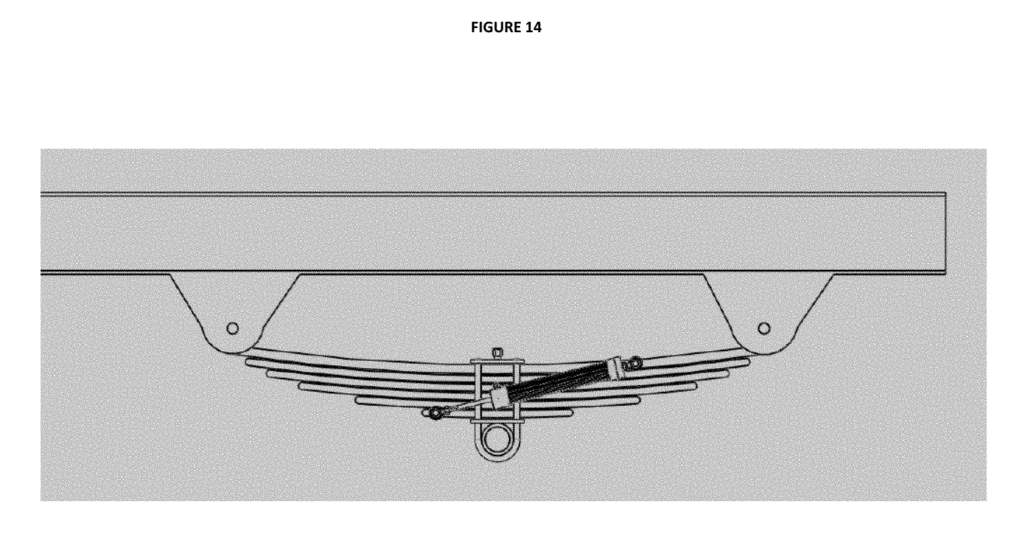

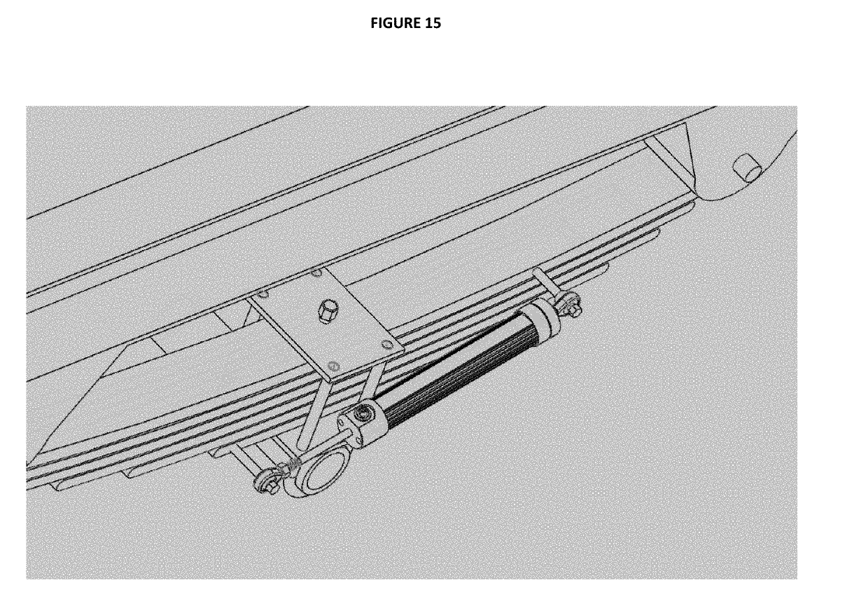

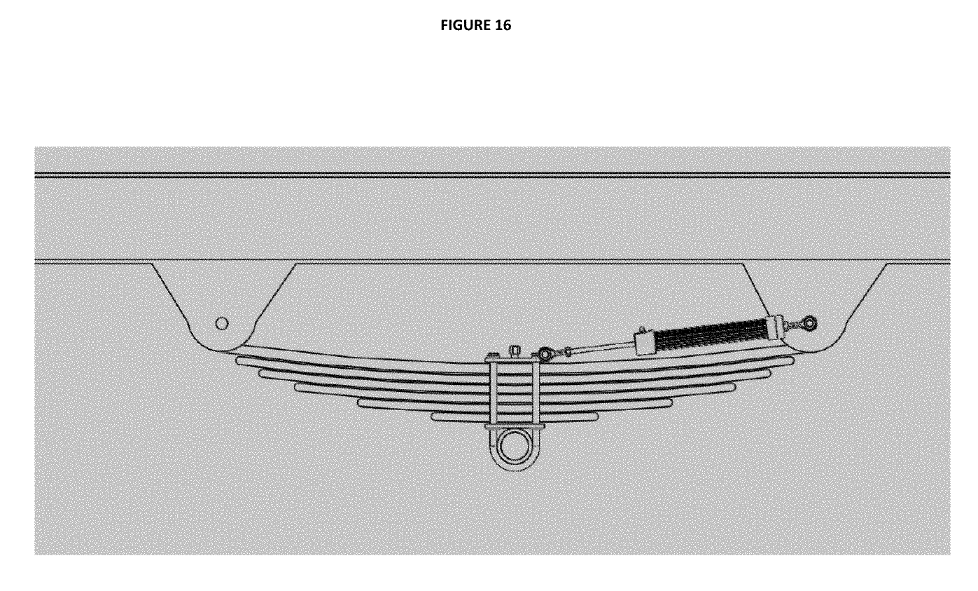

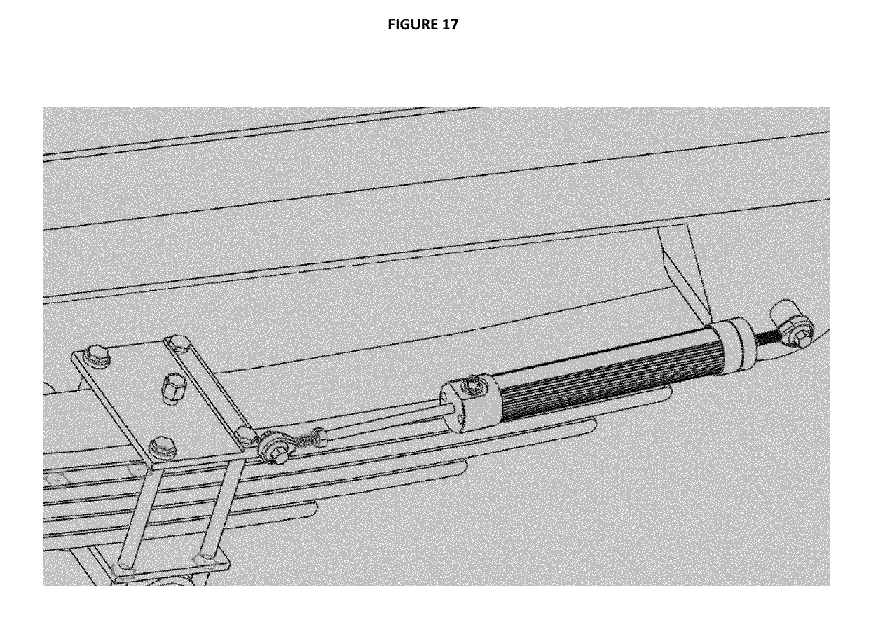

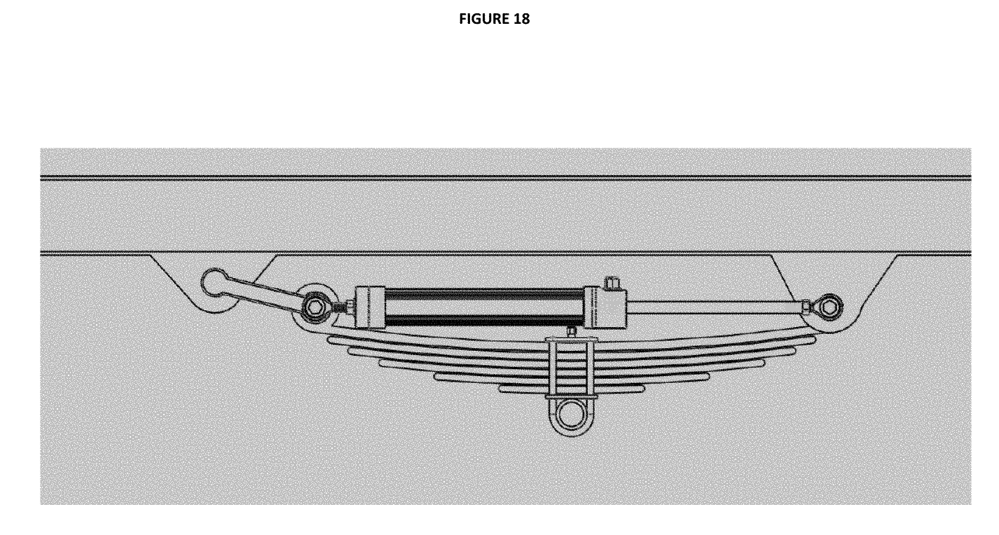

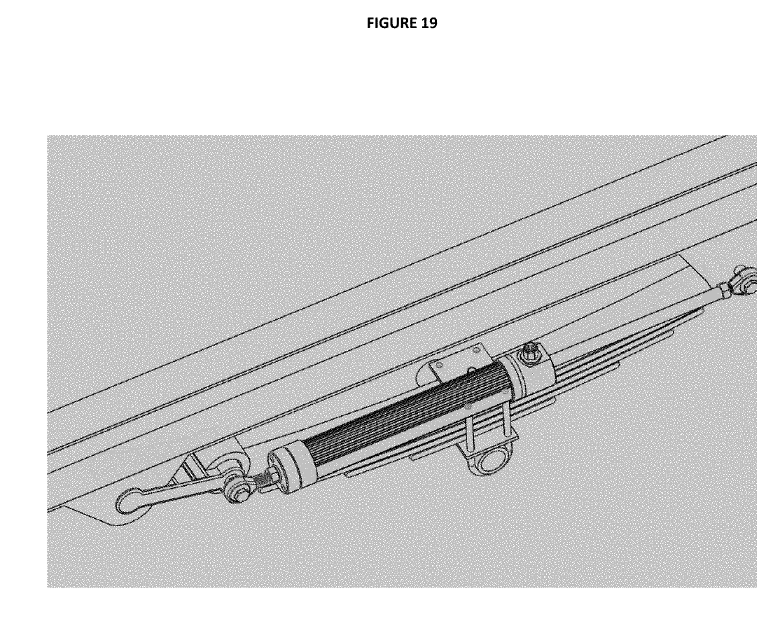

The rectilinear displacement transducer with inductive or resistive effect sensors can be installed directly on the vehicle's springs, without using other parts of it, in the following ways, considering each one of its extremities: a) fixed to the spring clamps (FIGS. 10 and 11); b) fixed to the fixed spring bearing and the master pin of the leaf spring (FIGS. 12 and 13); c) fixed to the leaf spring blades using the threaded holes and studs directly on the leaf spring blades (FIGS. 14 and 15); d) fixed to the fixed spring bearing and the leaf spring U-bolt's bracket (FIGS. 16 and 17); or e) fixed to the fixed spring bearing and the mobile bearing/shackle of the leaf spring (FIGS. 18 and 19).

In the installation version with fastening to the spring clamps (as shown in FIG. 10), the sensors are fastened on both sides by the spring clamp bolts, using screws or studs fastened to the bolts, with nuts and washers (FIG. 11).

In the installation version with fastening to the fixed spring bearing and the spring leaf master pin (FIG. 12), the sensors are fastened at one extremity to the fixed spring bearing and at the other extremity by the leaf spring master pin, using plates or brackets, bolts and studs fixed with nuts and washers (FIG. 13).

In the installation version with fastening to the leaf spring blades using the holes with threads and studs directly on the leaf spring blades (FIG. 14), the sensors are fixed, at both extremities, directly onto the leaf spring blades using bolts and studs fastened with nuts and washers (FIG. 15).

In the installation version with fastening to the fixed spring bearing and the leaf spring U-bolt's bracket (FIG. 16), the sensors are fastened at one extremity to the fixed spring bearing and at the other extremity by the leaf spring U-bolt's bracket, using plates or brackets, bolts, and studs fixed with nuts and washers to the fixed bearing and clamps (FIG. 17).

In the installation version with fastening to the fixed spring bearing and mobile bearing/shackle of the leaf spring (FIG. 18), the sensors are fastened at one extremity to the fixed spring bearing and at the other extremity to the mobile bearing/shackle of the leaf spring, using bolts and studs fastened with nuts and washers (FIG. 19).

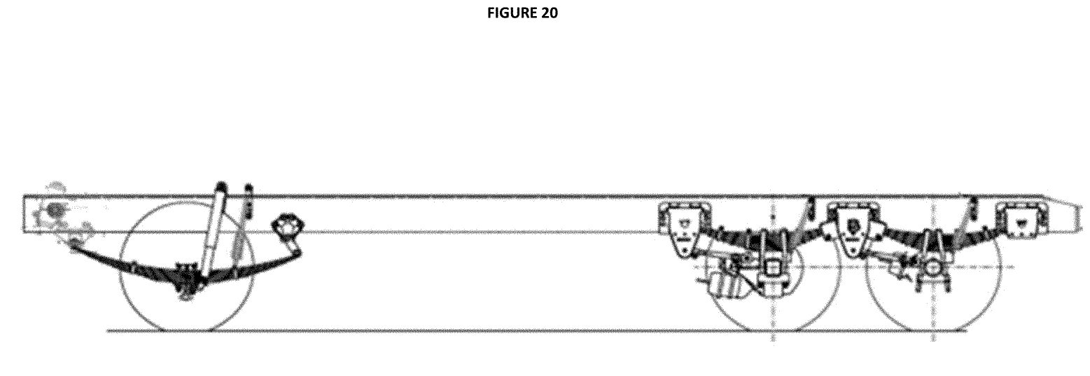

### Detailed Description of the Sensor Fixing Configuration Between the Vehicle's Chassis and Springs—FIGS. 20 to 27

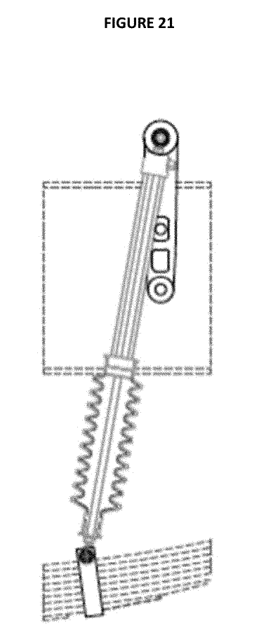

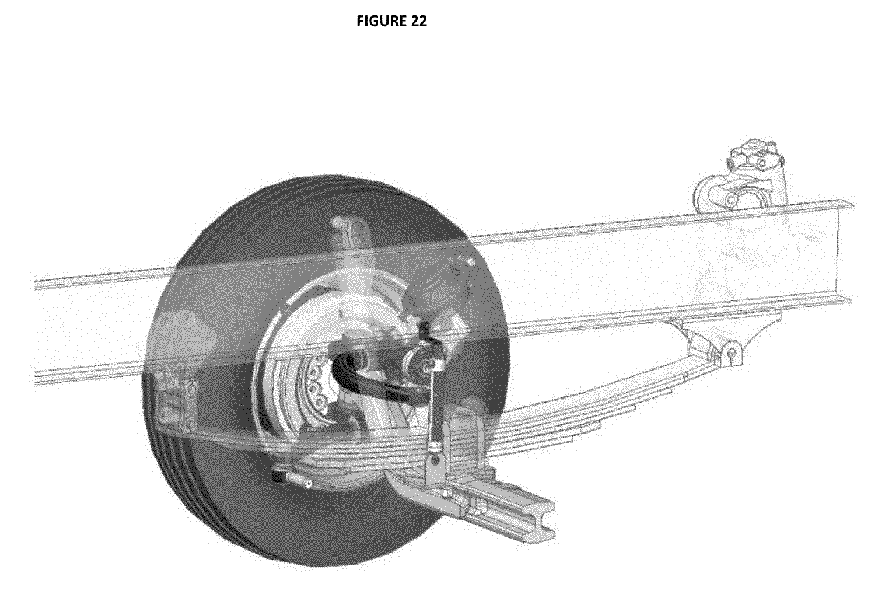

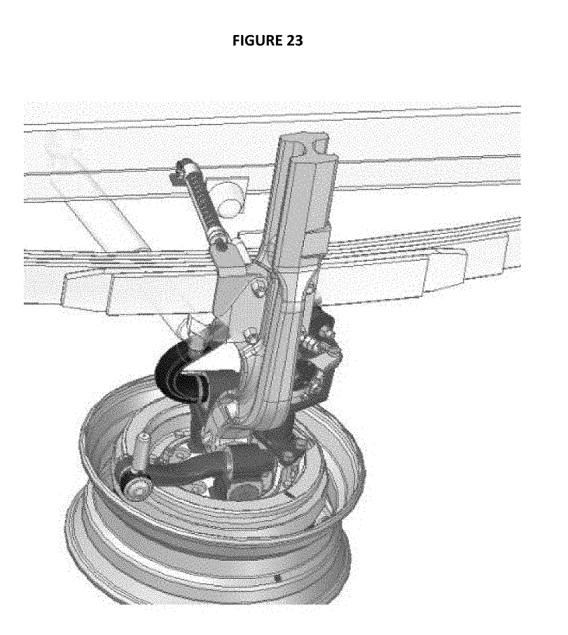

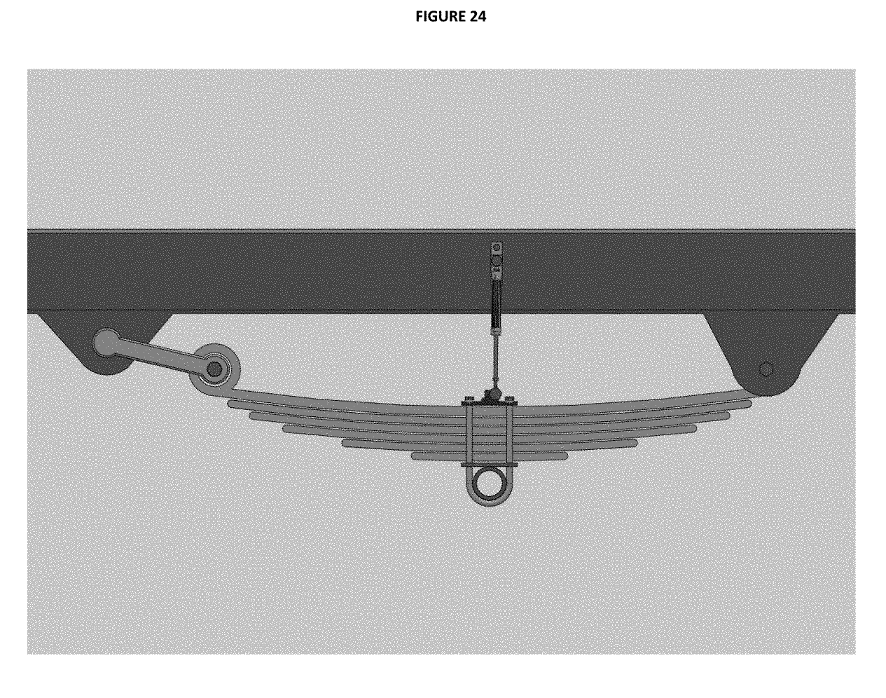

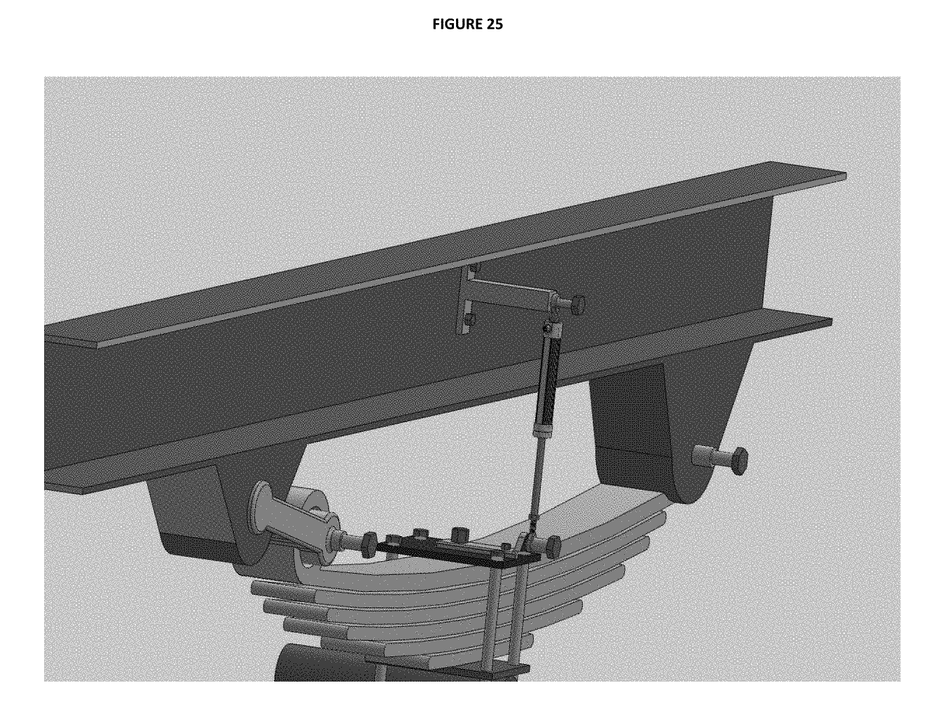

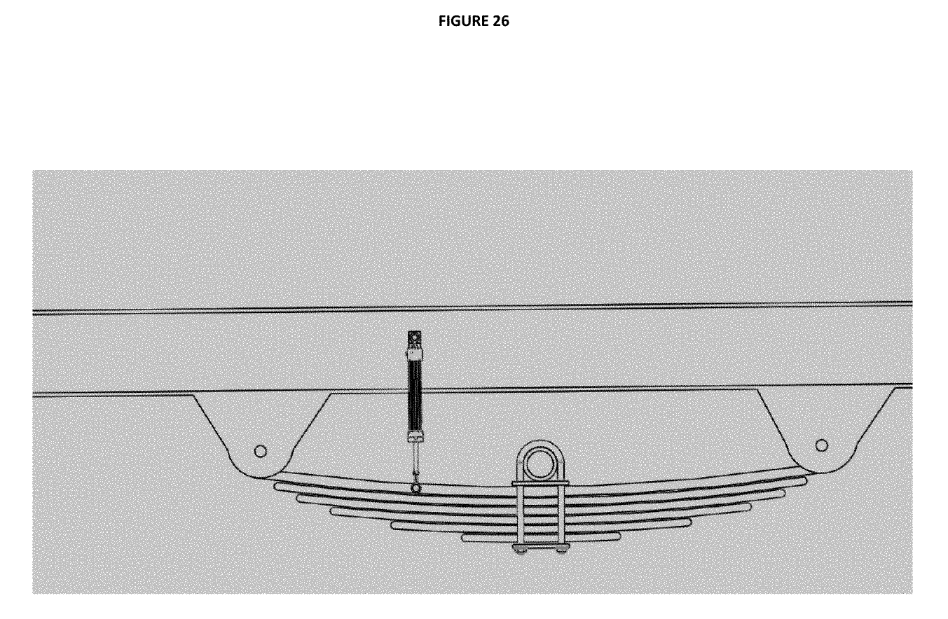

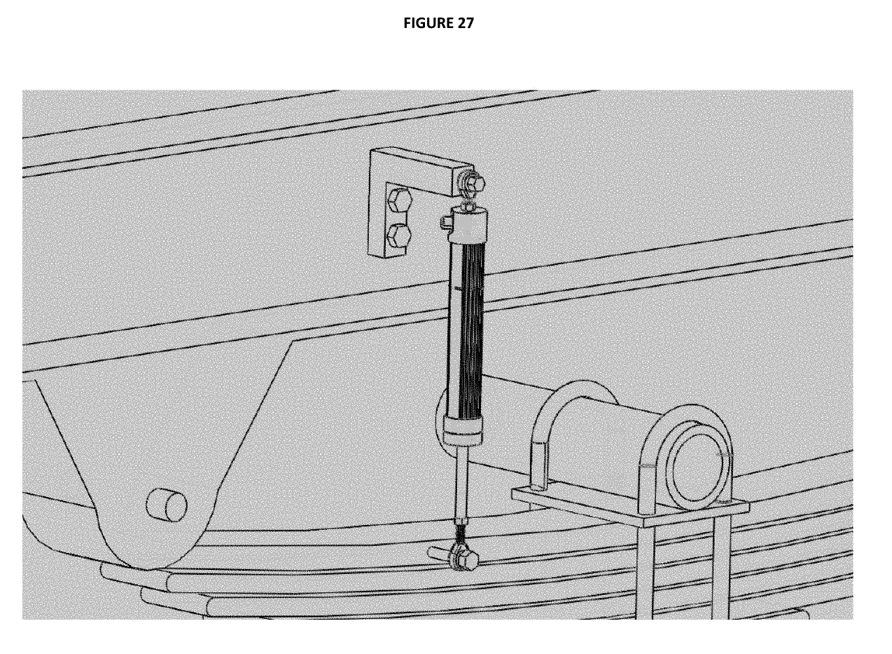

The rectilinear displacement transducer with inductive or resistive effect sensors can be installed between the vehicle's chassis and springs, in the following ways, considering each one of its extremities: a) fixed between the spring clamp and a bracket fastened to the chassis (FIGS. 20 and 21); b) fixed between a bracket on the spring U-bolt and a bracket fastened to the chassis (FIGS. 22 and 23); c) fixed between a bracket fixed on the leaf spring's master pin and a bracket fastened to the chassis (FIGS. 24 and 25); d) fixed with a hole or stud on the leaf spring blades and to a bracket fastened to the chassis (FIGS. 26 and 27).

All versions listed above (“a” to “d”) have the fixation of one the sensor ends to a “J” or “L” bracket fastened to the vehicle's chassis, inside or outside the chassis, by bolts, studs, nuts and washers.

In the installation version with fixation to the spring clamp (according to the overview of FIG. 20), the sensors are fastened by the spring clamp bolts, using bolts, or studs fastened to the bolts, with nuts and washers (FIG. 21).

In the installation version with fixation on the spring U-bolt's bracket (FIG. 22), the sensors are fastened to the springs by a bracket screwed at the base of the leaf spring's U-bolt, using bolts, or studs fastened to the bolts, with nuts and washers (FIG. 23).

In the installation version with fixation to a bracket fixed to the leaf spring's master pin (FIG. 24), the sensors are fastened on a bracket screwed to the upper part of the base of the leaf spring master pin using bolts, or studs fastened to the bolts, with nuts and washers (FIG. 25).

In the installation version with fixation to a hole or stud on the leaf spring blades (FIG. 26), the sensors are fastened directly on the leaf spring blade using bolts, or studs fastened to the bolts, with nuts and washers (FIG. 27).

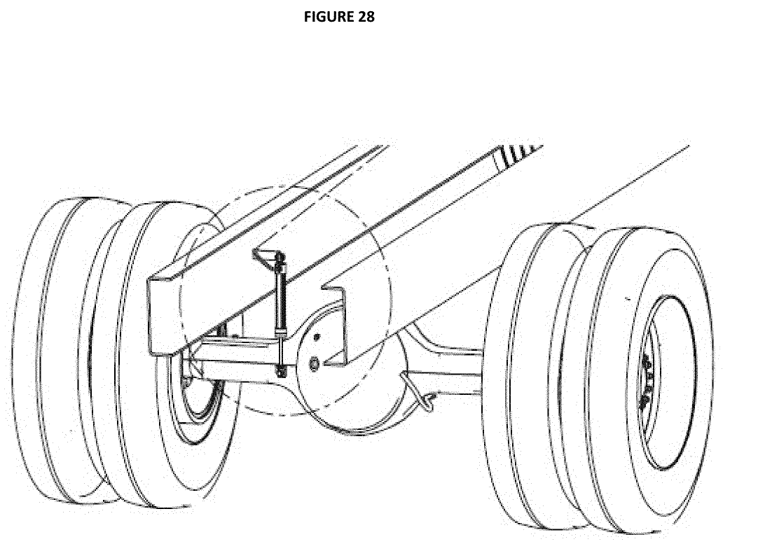

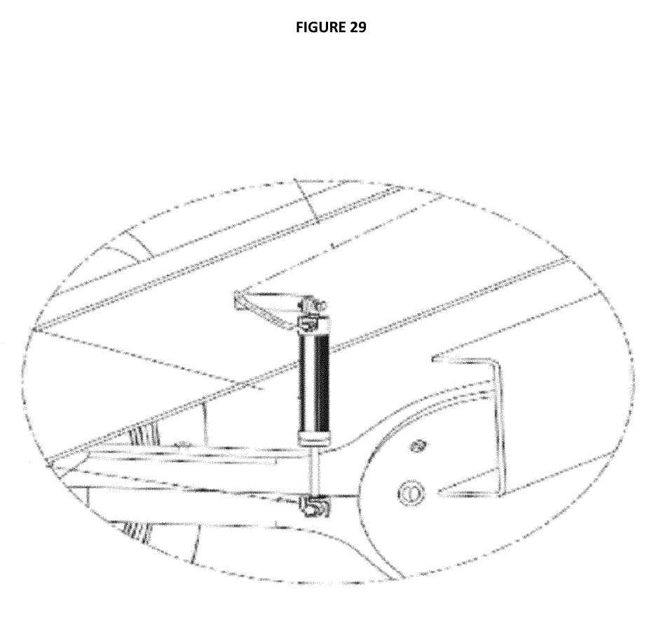

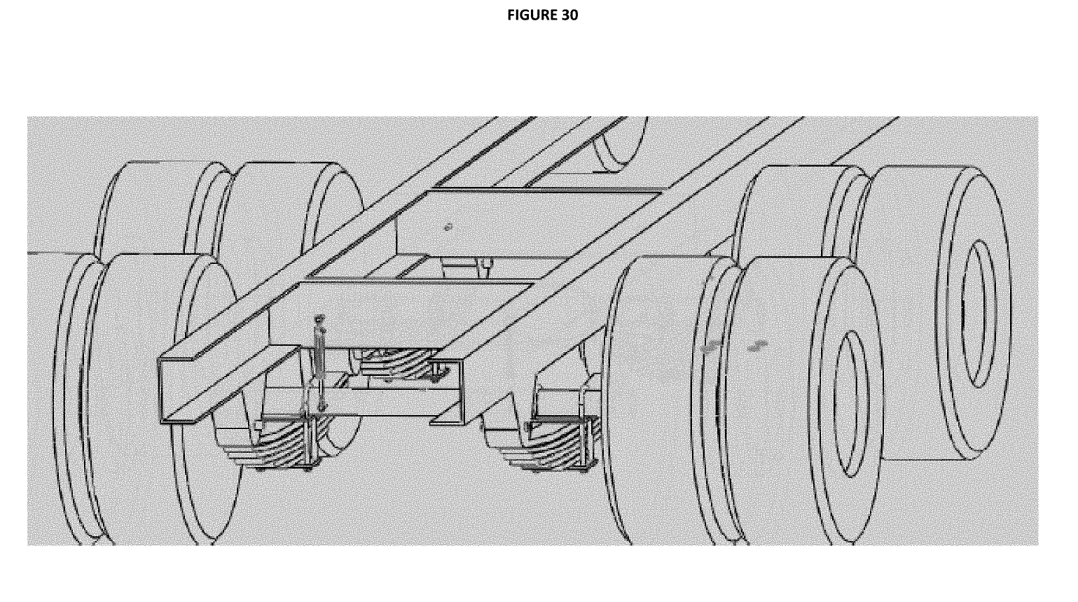

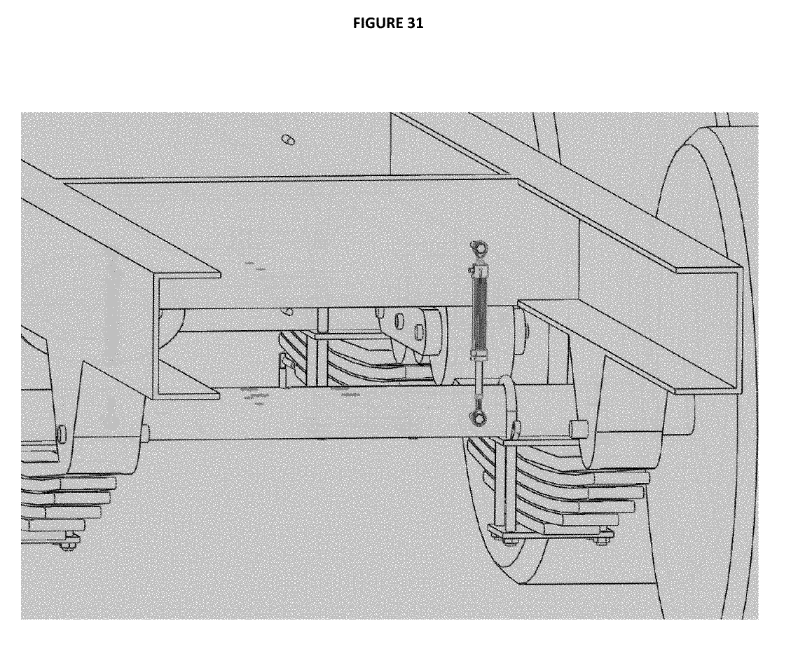

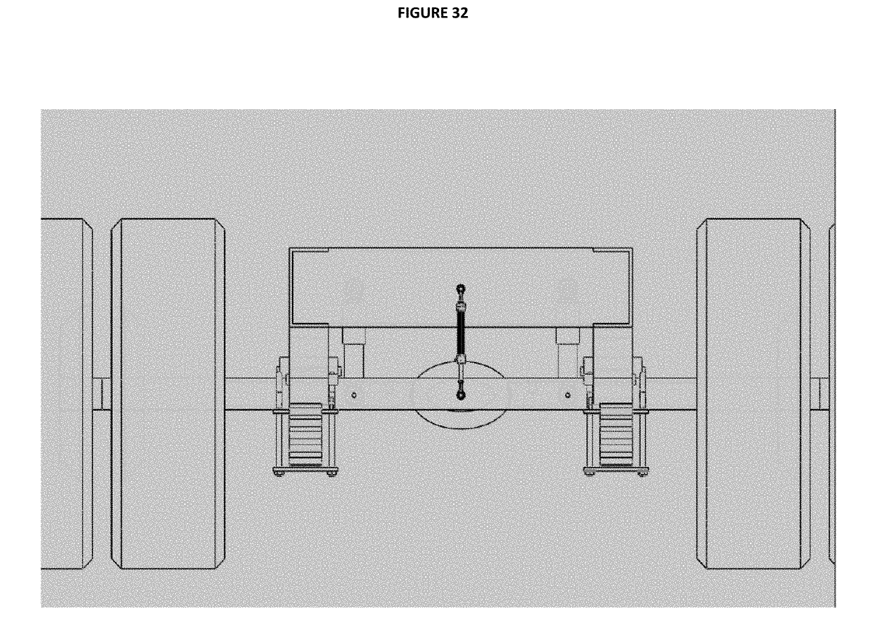

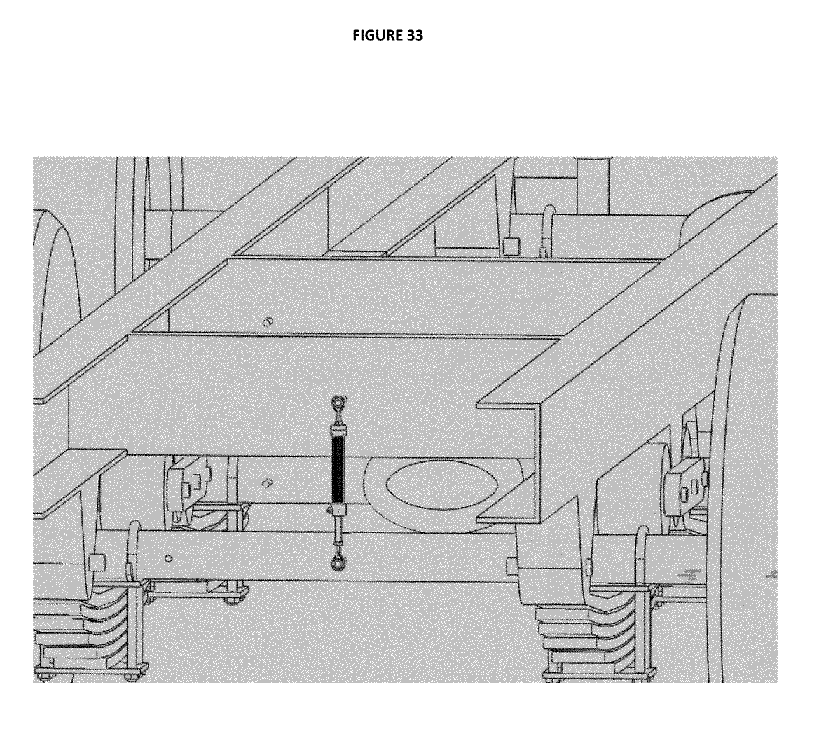

### Detailed Description of the Sensor Fixing Configuration Between the Vehicle's Chassis and Axle—FIGS. 28 to 33

The rectilinear displacement transducer with inductive or resistive effect sensors can be installed between the vehicle's chassis and axle (FIGS. 28 to 33), using both “J” or “L” brackets on the chassis (fastened to its Inside or outside part) and on the axle, using bolts, studs, nuts and washers.

### Detailed Description of the Multipoint Automatic and Semi-Automatic Calibration System and Calibration System for Suspended Axles

The onboard load weight measurement system for vehicles has three calibration systems: manual, semi-automatic and automatic. Furthermore, it is possible to calibrate the eventually suspended axles of the vehicle.

### Dynamics of the System's Calibration Process

The dynamics of the system's calibration process works as follows: the user positions the vehicle(s) on ground scale(s), which will measure the weight in kilograms (kg) or pounds (lbs.) by using load cells (20), whereas such information is stored by the user for later use in the calibration process. At the same time, the sensors installed in the vehicle (17)(18) will point to a variation of the internal electrical signal, providing such values in volts, millivolts, amps or milliamps on the display (4), being necessary for the user to store such information for later use in the calibration process.

These two pieces of information (value provided by the ground scale and value provided by the sensor(s)) are used to generate 1 (one) calibration point in the calibration table, with at least 2 (two) calibration points needed for the basic operation of the onboard load weight measurement system, up to a maximum of 10 (ten) calibration points to optimize system performance in all weight ranges. Thus, the abovementioned process must be repeated in multiple loading situations in a vehicle, in order to generate calibration points for, for example: Tare, ¼ (one fourth) of total load, ½ (half) of total load, ¾ (three fourths) of total load, Total Gross Weight, Load Excess, etc. After all calibration points data are collected, they must be inserted in the module(s) of the system, so that the system starts automatically comparing the information and correctly informs the user the weight(s) of the vehicle(s).

In the manual calibration version, the user must read, write down and manually insert in the display (4) all information generated by the ground scale (1) and the sensors (17)(18), which is permitted by this system if desired by the user.

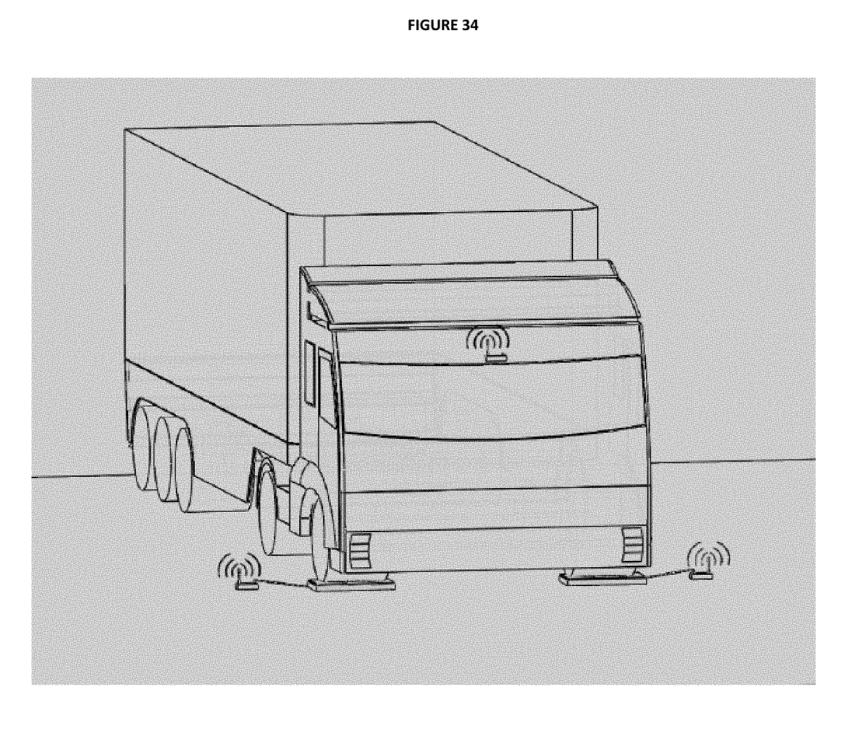

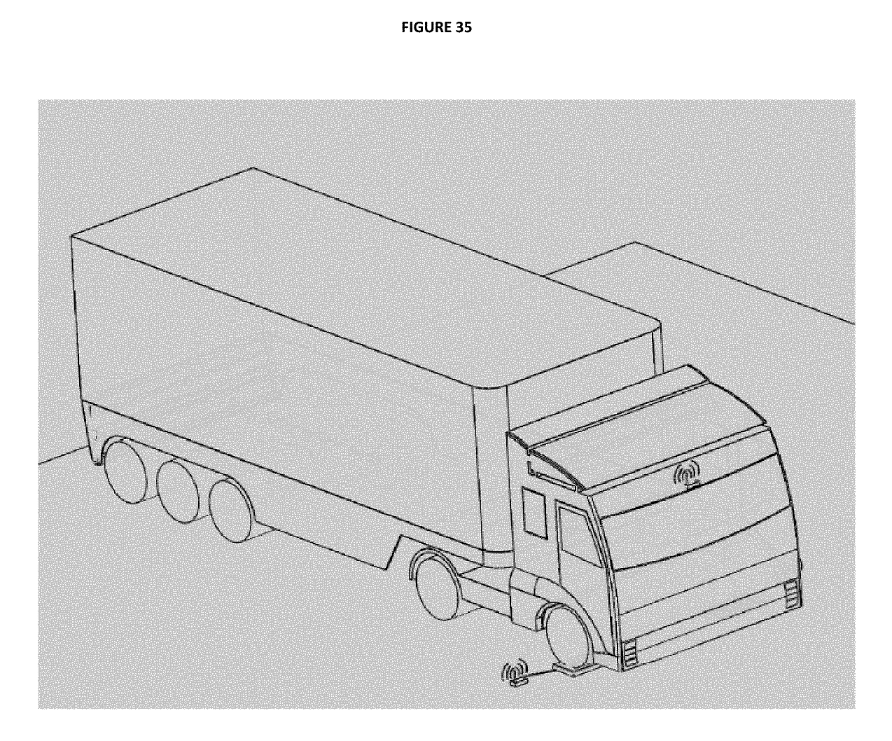

The calibration system, in its semiautomatic and automatic versions (FIGS. 34 and 35), operates remotely by using ground scales (1) that communicate with the modules (2) of the onboard load weight measurement system by means of a data transmission/reception module (3) or directly by cable, thereby communicating and exchanging weight information in kilograms (kg) or pounds (lbs.) of the ground scale with electrical signal information in volts, millivolts, amps or milliamps of the sensors installed in the vehicle (17)(18), comparing such information over time and auto-calibrating the system when the vehicle stops or passes over the ground scales using a timestamp.

The number of ground scales required to generate the calibration points in the calibration system is directly proportional to the number of sensors installed in the vehicles equipped with the onboard load weight measurement system.

Thus, for example, in a vehicle that has only 1 (one) sensor equipped in a group of axles, only 1 (one) ground scale will be required to measure that group of axles and only the weight per group of axles (total and net) will be capable of being calculated by the onboard load weight measurement system. In another example, a vehicle that has 2 (two) sensors per axle will require 1 (one) ground scale for each axle extremity (FIG. 34), with the onboard load weight measurement system being then capable of calculating and reporting the weight per axle extremity/wheel, axle, axle side and axle group (gross and net).

This is the dynamics of the calibration process, being the system able to perform this procedure semi-automatically or automatically, according to the detailed descriptions below.

### Semi-Automatic Calibration

In the semi-automatic form, the user inserts a command on the display (4) to initiate the calibration process, positioning the vehicle equipped with the onboard load weight measurement system over the ground scales (1), then initiating the dynamics of the calibration process of the system described above. In this semiautomatic form, however, the ground scales will directly transmit the weight information in kilograms (kg) or pounds (lbs.) to the module (2) of the onboard load weight measurement system via cable; or data transmission/reception module (3); or radio frequency, Wi-Fi or Bluetooth; from the moment the weight is stable on the ground scale (FIGS. 34 and 35).

Thus, the information sent by the ground scales (in kilograms or pounds) is automatically compared with the information sent by the sensors (17)(18) (in volts, millivolts, milliamps or amperes) to the module (2), automatically generating a calibration point, which is saved in the system modules (2) and informed to the user on the display (4).

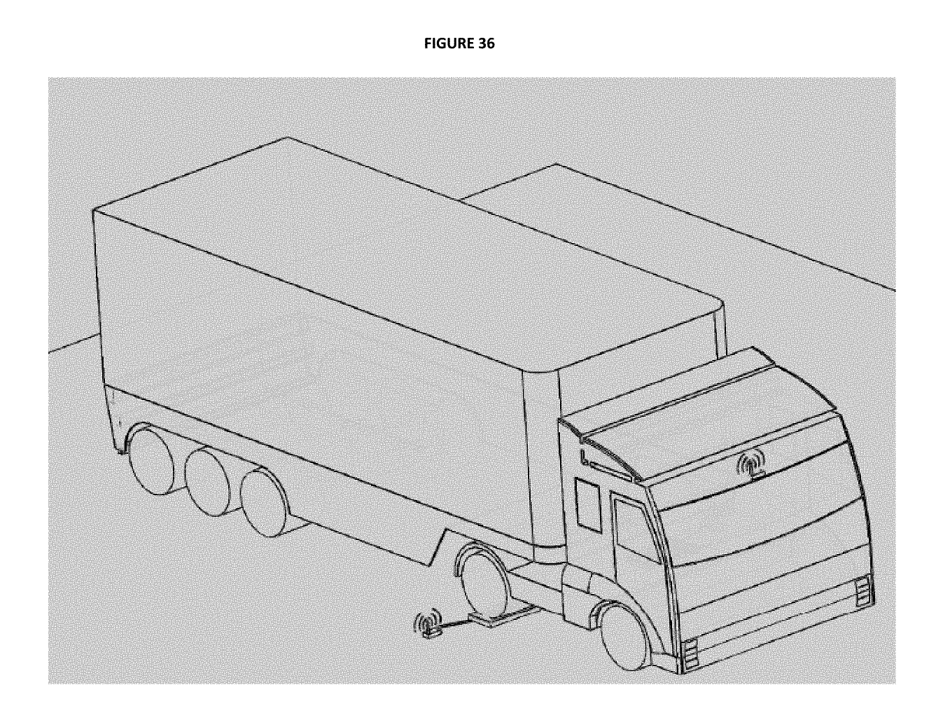

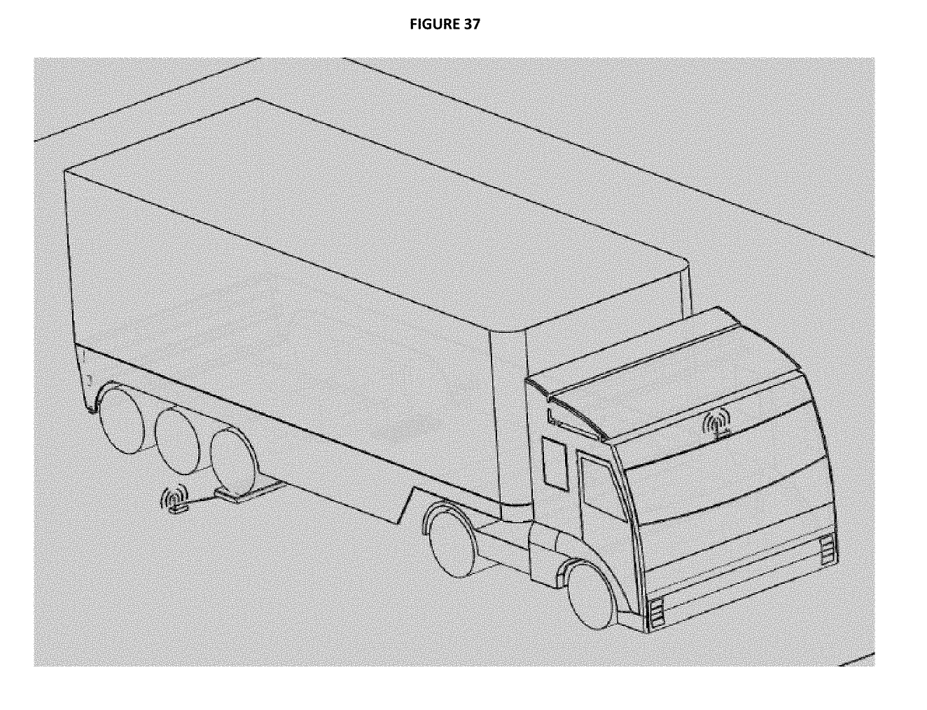

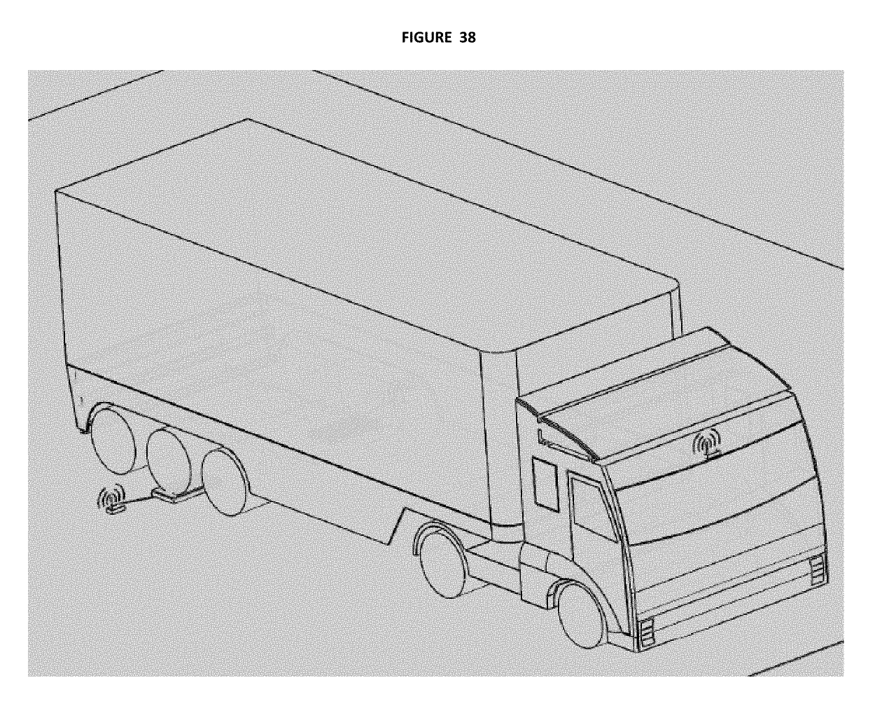

The user can then confirm the calibration point, or generate more sequential calibration points (FIGS. 36, 37 and 38) or end the process.

### Automatic Calibration

In the automatic form, the calibration of one of the calibration points of the onboard load weight measurement system occurs automatically, simply because the vehicle passes over a ground scale (1). To perform the entire calibration process, the vehicle must pass several times over the ground scale (1) with different loads, as described in the dynamics of the system calibration process, in order to calibrate the diverse calibration points.

The process begins when the vehicle equipped with the onboard load weight measurement system passes over the ground scales (1) equipped with a module of the system (1)(2), which send to the module (2) located in the vehicle, an automatic command via radio frequency, Wi-Fi, Bluetooth or the communication peripherals (22), to start the calibration process. The vehicle module then automatically compares the information sent by the ground scales (in kilograms or pounds) with the information sent by the sensors (17)(18) equipped in the vehicle (in volts, millivolts, milliamps or amps), statically (vehicle stopped with stable weight) or dynamically through the “weight peak” (vehicle moving over the ground scales), displaying the result of the calibration point generated directly on the display (4) of the system and automatically recording the calibration point in the system.

The display (4) gives an option to enter a password to start the calibration process, and can be blocked by third parties who have such a password. The system also provides a calibration counter, to generate greater control of the system and avoid fraud.

### Calibration System of Suspended Axles and Automatic Detection Via Algorithm

The calibration of the suspended axles is done exclusively manually, with the user informing the master module (2), through the system display (4), which axles are suspended at that time and which reference value in volts, millivolts, milliamps or amps captured up by the sensors (17)(18) are shown when the axles are in this position. Therefore, if the user suspends the axle later, the system will automatically detect this situation and adjust the weighing calculation.

The system also provides for automatic detection of suspended axles by using an algorithm in the firmware of the onboard load weight measurement system, which reads, compares and informs the user through the display (4) if the axle is suspended or not, adjusting the weighing calculation automatically.

This algorithm compares the values provided by the sensors in volts, millivolts, milliamps or amps to detect if they are static or in motion, detecting the axles that are suspended because the sensors are static in relation to the sensors of the other axles that are in movement in the vehicle.

1. ONBOARD LOAD WEIGHT MEASUREMENT SYSTEM FOR VEHICLES with air or mechanical suspension, or both, characterized for comprising:
a) a weight measurement master module (2) with up to eight communication channels, which can be interconnected to slave modules, with up to eight communication channels, by cable or wireless via data transmission/reception modules (3), whereas these modules are connected to rectilinear displacement transducer with inductive or resistive effect sensors (17) preferably installed in pairs on each axle of the vehicle, one at each end of the axle, fastened between the chassis (5) and the mechanical suspension (6); and/or to diverse sensors for air suspension (18) installed in the air line of the vehicle's air suspension (19) through a “T”, fastened between the chassis (5) and the air suspension (19);
b) displays (4) receiving the weighing information produced by the master and slave modules, by cable or wireless via data transmission/reception modules (3), whereas these displays can be concomitantly inserted in the vehicle cabin (9)(4), fastened to the sides of dollies/trailers (8)(4), or fastened to the ground scale(s) (1)(4).

2. ONBOARD LOAD WEIGHT MEASUREMENT SYSTEM FOR VEHICLES, according to claim 1, characterized by the fact that the system has connections and inputs for SD/mini SD memory card (10); diverse peripherals (21) such as printers, Wi-Fi modems, Bluetooth and the vehicle's original panel; USB connection (11), vehicle's original module (23), Can Bus Port (14), communication peripherals (22) by GSM, satellite, radio, telemetry and/or data logger technology; two RS485 ports (12)(15) and two RS232 ports (13)(16).

3. ONBOARD LOAD WEIGHT MEASUREMENT SYSTEM FOR VEHICLES, according to claim 1, characterized by the fact that the system enables to configure the fixation of the rectilinear displacement transducer with inductive or resistive effect sensors (17) on vehicles equipped with mechanical suspension, directly on the vehicle dampers, in the following ways: a) parallel to the dampers; b) in front of or behind the damper; or c) inside the damper.

4. ONBOARD LOAD WEIGHT MEASUREMENT SYSTEM FOR VEHICLES, according to claim 1, characterized by the fact that the system enables to configure the fixation of the rectilinear displacement transducer with inductive or resistive effect sensors (17) on vehicles equipped with mechanical suspension, directly on the vehicle's springs, in the following ways, considering each of its extremities: a) fixed to the spring clamps; b) fixed to the fixed spring bearing and the master pin of the leaf spring; c) fixed to the leaf spring blades using the threaded holes and studs directly on the leaf spring blades; d) fixed to the fixed spring bearing and the leaf spring U-bolt's bracket; or e) fixed to the fixed spring bearing and the mobile bearing/shackle of the leaf spring.

5. ONBOARD LOAD WEIGHT MEASUREMENT SYSTEM FOR VEHICLES, according to claim 1, characterized by the fact that the system enables to configure the fixation of the rectilinear displacement transducer with inductive or resistive effect sensors (17) on vehicles equipped with mechanical suspension, between the springs and the vehicle chassis, in the following ways, considering each of its extremities: a) fixed between the spring clamp and a bracket fastened to the chassis; b) fixed between a bracket on the spring U-bolt and a bracket fastened to the chassis; c) fixed between a bracket fixed on the leaf spring's master pin and a bracket fastened to the chassis; d) fixed with a hole or stud on the leaf spring blades and to a bracket fastened to the chassis;

6. ONBOARD LOAD WEIGHT MEASUREMENT SYSTEM FOR VEHICLES, according to claim 1, characterized by the fact that the system enables to configure the fixation of the rectilinear displacement transducer with inductive or resistive effect sensors (17) on vehicles equipped with mechanical suspension, between the vehicle's chassis and axle, using “J” or “L” brackets on the chassis (fixed to the chassis' inside or outside part) and on the axle, using bolts, stud bolts, nuts and washers.

7. MULTIPOINT AUTOMATIC AND SEMI-AUTOMATIC CALIBRATION SYSTEM, characterized by the fact that it comprises a calibration process for the onboard load weight measurement system for vehicles by using ground scales (1), data transmission/reception modules (3) or cables, onboard load weight measurement system modules (2) and sensors installed in the vehicle (17)(18), with the possibility of storing up to 10 (ten) calibration points in each module channel (2).

8. MULTIPOINT AUTOMATIC AND SEMI-AUTOMATIC CALIBRATION SYSTEM, according to claim 7, characterized by the fact that the calibration process can be performed semi-automatically, by automatic transmission of the weighing data of the ground scale(s) (1) and the system sensors (17)(18) to the module (2) via cable, or wireless via the data transmission/reception module (3) or radio frequency or Wi-Fi or Bluetooth; as soon as the weight is stable on the ground scale (1), informing the performed calibration point directly on the display (4) of the onboard load weight measurement system.

9. MULTIPOINT AUTOMATIC AND SEMI-AUTOMATIC CALIBRATION SYSTEM, according to claim 7, characterized by the fact that the calibration process can be carried out in an automatic manner, statically or dynamically, by automatic transmission of the weighing data of the ground scale(s) (1) and the system's sensors (17)(18) to the module (2) via cable, or wireless via the data transmission/reception module (3) or radio frequency or Wi-Fi or Bluetooth; from the moment the vehicle simply passes over the ground scale (1), statically (parked vehicle with stable weight) or dynamically (vehicle moving through the ground scale), informing the performed calibration point directly on the display (4) of the onboard load weight measurement system.

10. MULTIPOINT AUTOMATIC AND SEMI-AUTOMATIC CALIBRATION SYSTEM, according to claim 7, characterized by the fact that it comprises a calibration process to detect suspended axles in the vehicle; and for automatic detection of suspended axles by using an algorithm in the firmware of the onboard load weight measurement system.
